(19) United States
(12) Patent Application Publication
(10) Pub. No.: US 2017/0132652 A1
(43) Pub. Date: May 11, 2017

(54) Systems and Methods for Processing Loyalty Rewards

(71) Applicant: MASTERCARD INTERNATIONAL INCORPORATED, Purchase, NY (US)

(72) Inventors: Iain Kedzlie, Buckinghamshire (GB); Rohit Chauhan, Sommers, NY (US)

(21) Appl. No.: 14/938,603

(22) Filed: Nov. 11, 2015

(51) Int. Cl. G06Q 30/02

(52) U.S. Cl. CPC G06Q 30/0226

(57) ABSTRACT

Systems and methods are provided for use in processing loyalty rewards. One exemplary method includes receiving a message associated with a transaction to a payment account where the message includes a primary account number (PAN) for the payment account, a merchant identifier for a merchant involved in the transaction, and at least one purchase parameter. The method also includes identifying, in a data structure, a loyalty account associated with both the merchant identifier and the payment account, and causing a loyalty account value associated with the loyalty account to be updated based on the at least one purchase parameter, whereby the loyalty account is updated by use of the payment account without a consumer associated with the payment account and/or the transaction separately presenting an indicator of the loyalty account to the merchant.

### FIELD

The present disclosure generally relates to systems and methods for processing loyalty rewards, and in particular, to associating loyalty reward accounts to payment accounts.

### BACKGROUND

This section provides background information related to the present disclosure which is not necessarily prior art.

Consumers are known to use one or multiple payment accounts to fund transactions for different types of products (e.g., goods and services, etc.), from different merchants. The transactions result in transaction data, associated with authorization, settlement and/or clearing of the transactions, being compiled by the merchants, issuers of the payment accounts, acquirers associated with the merchants, and the payment networks processing the transactions. Additional transaction data may be compiled specific to the individual transactions. Separately, consumers are known to use loyalty accounts associated with merchants to accumulate rewards or benefits for making purchases at the merchants or for being loyal to the merchants. The consumers often associate different transactions with their particular loyalty account by presenting separate loyalty identifiers (e.g., loyalty cards, etc.) at the time of the purchase transactions. As such, the consumers typically maintain the loyalty identifiers in their wallet, purse, etc., and often have multiple such loyalty identifiers, particularly when the consumers have multiple loyalty accounts at multiple different merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in associating loyalty accounts with payment accounts;

FIG. 2 is a block diagram of a computing device that may be used in the exemplary system of FIG. 1;

FIG. 3 is an exemplary method, which may be implemented in connection with the system of FIG. 1, for processing loyalty rewards in connection with a transaction to a payment account wherein loyalty account information relating to the transaction is appended to transaction data for the transaction;

FIG. 4 is another exemplary method, which may be implemented in connection with the system of FIG. 1, for processing loyalty rewards in connection with a transaction to a payment account;

FIGS. 5 and 6 are exemplary interfaces for displaying loyalty account information to a consumer, which may be used in connection with the system of FIG. 1 and/or the method of FIG. 3 and/or the method of FIG. 4; and

FIG. 7 is an exemplary method, which may be implemented in connection with the system of FIG. 1 and/or either of the methods of FIGS. 3 and 4, for managing association of loyalty accounts with a payment account.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Many merchants, banks, and other entities offer loyalty reward programs as a strategy to encourage business and repeat business from consumers. The loyalty reward programs take many forms throughout various industries, and can include something as simple as a punch card at a local sandwich shop to a loyalty card that accrues value for transactions at one or more particular merchants. Because many merchants offer loyalty rewards programs, consumers may maintain multiple such loyalty accounts, and consequently, multiple loyalty account identifiers, such as, for example, loyalty cards, punch cards, etc., which have to be present (or otherwise presented) for use at the merchants. The systems and methods herein permit loyalty accounts to be associated with payment accounts so that, when the payment accounts are used in transactions at merchants associated with one of the loyalty accounts, the loyalty accounts can be automatically updated as appropriate. As such, any rewards associated with the transactions are attributed to the appropriate loyalty accounts and/or consumers, without the consumers involved in the transactions having to separately present loyalty account indicators to the merchants.

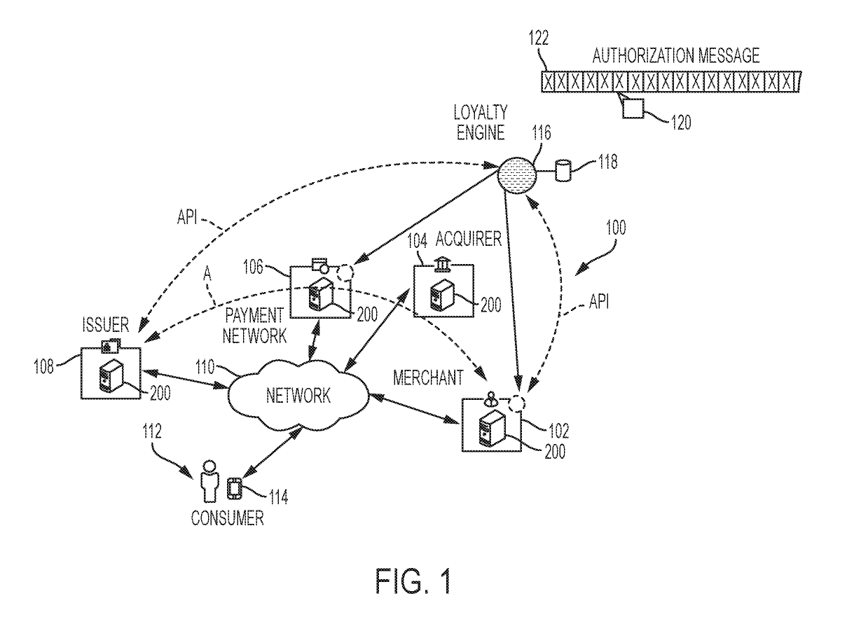

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, a relation of a loyalty engine to a payment network, an issuer, and/or a merchant, etc.

The system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between one or more of the merchant 102, the payment network 106, and a consumer 112 (or a consumer's communication device 114), etc.

The merchant 102 is generally associated with products (e.g., goods and/or services, etc.), which are offered for sale and are sold to consumers in the system 100, including consumer 112. The merchant 102 may offer the products for sale in physical locations or through websites, or through other web-based store fronts, as desired. In addition, the merchant 102 may offer a loyalty account, which may include a punch card, purchase count, points, dollars, etc. type account, to the consumer 112, whereby rewards are provided to the consumer 112, through the loyalty account, for making transactions at the merchant 102. It should be appreciated that, while only one merchant 102 and one consumer 112 are illustrated for ease of reference, multiple merchants and/or consumers may be added in the system 100, often with each merchant offering loyalty accounts to the consumers, whereby each consumer is associated with one or more loyalty accounts with the different merchants.

In some embodiments, the consumer 112 is able to fund transactions with the merchant 102 for one or more of the products, via a payment account. Use of the payment account to fund such transactions may be authenticated by providing the correct information to the merchant 102 (e.g., a primary account number (PAN), expiration date, account holder name, etc.). The account information may be manually provided by the consumer 112 or it may be provided through other means, such as by swiping a credit card through a magnetic card reader or presenting data for an electronic wallet. The merchant 102 may then update a loyalty account value for the consumer's loyalty account based on the transaction.

For example, the consumer 112 may initiate a transaction with the merchant 102, for the purchase of a product, by presenting a payment device associated with the consumer's payment account to the merchant 102 (e.g., a credit card, a debit card, a fob, a smartcard, a web-based e-wallet application, etc.). In turn, the merchant 102 submits an authorization request (broadly, a transaction message) to the acquirer 104 (associated with the merchant 102) for the transaction, to determine whether the payment account is in good standing and whether there is sufficient funds and/or credit to cover the transaction. The authorization request is transmitted along path A in the system 100, as referenced in FIG. 1. The acquirer 104 communicates the authorization request with the issuer 108 (associated with the consumer's payment account), through the payment network 106, such as, for example, through MasterCard®, VISA®, Discover®, American Express®, etc. In turn, if approved, an authorization reply or response (indicating the approval of the transaction) (broadly, a transaction message) is transmitted back from the issuer 108 to the merchant 102, along path A, thereby permitting the merchant 102 to complete the transaction. The transaction is later cleared and/or settled (via appropriate transaction messages such as clearing messages and/or settlement messages) by and between the merchant 102, the acquirer 104, and the issuer 108 (by appropriate agreements). If declined, however, the authorization reply (indicating a decline of the transaction) is provided back to the merchant 102, along the path A, thereby permitting the merchant 102 to halt or terminate the transaction.

Transaction data is generated, collected, and stored as part of the above interactions among the merchant 102, the acquirer 104, the payment network 106, the issuer 108, and the consumer 112 (and included in the various transaction messages). The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100 as used or needed. The transaction data may include, for example, primary account numbers (PANs) for consumers involved in the transactions, amounts of the transactions, merchant IDs for merchants involved in the transactions, merchant category codes (MCCs), dates/times of the transactions, products purchased and related descriptions or identifiers, etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, the consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein.

With continued reference to FIG. 1, the consumer is associated with the communication device 114. In this exemplary embodiment, the communication device 114 is a portable communication device, such as, for example, a smartphone, a tablet, a laptop, etc. The communication device 114 may include, or may be associated with, a web-based loyalty application (e.g., as a stand-alone application or in connection with an e-wallet application, etc.), which includes a unique app identifier or (ID). In connection therewith, the communication device 114 may be configured, by the loyalty application, to interact with a loyalty engine 116 to receive information about the consumer's different loyalty accounts (or offers associated therewith) from different parts of the system 100 (e.g., the merchant 102, the payment network 106, the issuer 108, etc.), and/or enter and/or provide information about the consumer's different loyalty accounts from the consumer 112. This will be described in more detail hereinafter.

Further, while one acquirer 104, one payment network 106, and one issuer 108 are illustrated in FIG. 1, it should be appreciated that any number of these entities (and their associated components) may be included in the system 100, or may be included as a part of systems in other embodiments, consistent with the present disclosure.

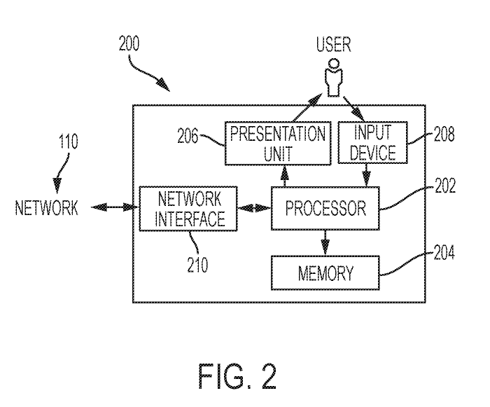

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in, computing device 200, coupled to the network 110. In addition, the loyalty engine 116 in the system may be considered a computing device consistent with computing device 200. Further, the computing devices 200 associated with these parts of the system 100, for example, may include a single computing device, or multiple computing devices located in close proximity or distributed over a geographic region, again so long as the computing devices are specifically configured to function as described herein. In addition, the communication device 114, which is associated with consumer 112, can also be considered a computing device consistent with computing device 200 for purposes of the description herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, loyalty account information (e.g., loyalty account indicators, etc.), consumer profiles, loyalty account requirements, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., loyalty account totals, etc.), visually, for example, to a user of the computing device 200 such as the consumer 112 in the system 100; users associated with one or more of the merchant 102, the acquirer 104, the payment network 106, and the issuer 108; etc. It should be further appreciated that various interfaces (e.g., as defined by web-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices. In addition, the computing device 200 includes an input device 208 that receives inputs from the user (i.e., user inputs) such as, for example, loyalty account information, etc. The input device 208 may include a single input device or multiple input devices. The input device 208 is coupled to (and in communication with) the processor 202 and may include, for example, one or more of a keyboard, a pointing device, a mouse, a stylus, a barcode scanner, a QR code scanner, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the loyalty engine 116 is specifically configured, by computer executable instructions, to perform one or more of the operations described herein. As indicated by the solid arrow lines in FIG. 1, the loyalty engine 116 may be associated with at least one of the merchant 102 and the payment network 106 in the illustrated system 100. However, it should be appreciated that the loyalty engine 116 may be associated with, or incorporated with, other parts of the system 100, in other embodiments, including, for example, the issuer 108, the communication device 114, etc.

Also, the system 100 is illustrated as including only one loyalty engine 116. In various other embodiments, however, multiple loyalty engines may be associated with multiple parts of the system 100 (e.g., the merchant 102 and the payment network 106, multiple merchants, multiple issuers, etc.), whereby the loyalty engines may operate, as described herein, in cooperation together, or separately, for the consumer 112, or for more than a single consumer and/or payment account. Additionally, the operations described herein as executed by the loyalty engine 116 may, in some embodiments, be divided between the multiple loyalty engines, located together or distributed over a geographic region, in the system 100. For example, one loyalty engine (or a part of the loyalty engine 116) (e.g., associated with the payment network 106, etc.) may determine if a payment account used in connection with a transaction is associated with a loyalty account, while another loyalty engine (or a part of the loyalty engine 116) (e.g., associated with the merchant 102, etc.) may update the identified loyalty account (e.g., a loyalty reward value for the account, etc.) based on the transaction (e.g., based on at least one purchase parameter for the transaction such as purchase total, etc.), etc.

In addition, as shown in FIG. 1, the system 100 includes a loyalty data structure 118, which is coupled to the loyalty engine 116. The loyalty data structure 118 may be a standalone part of the system 100, as shown in FIG. 1, or it may be included in memory of the loyalty engine 116 (e.g., memory 204, etc.) or elsewhere in the system 100. Likewise, it should be understood that the loyalty data structure 118 may be divided into separate structures, stored at separate parts of the system, and accessed from separate locations. The loyalty data structure 118 is populated with loyalty account information, loyalty enrollment options, and requirements, etc., for multiple consumers (including consumer 112), multiple payment accounts, and multiple loyalty accounts, etc.

In the illustrated embodiment, the loyalty engine 116 includes two application programing interfaces (APIs), which may be called by the merchant 102 and/or the issuer 108, etc. A call to each API is indicated by a dotted line in FIG. 1. It should be appreciated that the loyalty engine 116 may include more than or less than two APIs in other embodiments, which may be called by the same and/or other parts of the system 100 (e.g., a web-based application active in the consumer's communication device 114, etc.).

One API included in the loyalty engine 116 in the system 100 may be called by the issuer 108, for example, to register the consumer 112 to the loyalty engine 116 (as indicated by the dotted line). For example, the issuer may provide one or more web-based interfaces (e.g., websites, web-based applications, etc.), through which consumers (including consumer 112) are able to view payment account information (e.g., balances due, payment dates, rewards, statements, etc.). One of the web-based interfaces may include, as described herein, an option for the consumer 112 to associate his/her payment account to one or more loyalty accounts (for one or more merchants including, for example, merchant 102). Upon selection, by the consumer 112, of the option, the web-based interface provided by the issuer 108 calls the loyalty engine API, which is configured to solicit loyalty account information and/or enrollment options from the consumer 112 (via the issuer's web-based interface). The loyalty account information may include, for example, different loyalty account indicators for certain merchants with which the consumer 112 has loyalty accounts, etc., while enrollment options may include, for example, options to receive coupons or offers, etc. Further, the issuer 108 may cause certain consumer information to be delivered, via the API, to the loyalty engine 116 (with or without the consumer separately entering the information) such as, for example, the PAN for the consumer's payment account, the consumer's address, the consumer's contact information, etc. In turn, the loyalty engine 116 is configured to receive and store the loyalty account information and options (and other information, including the PAN, etc.), in the data structure 118, for use by the loyalty engine 116, as described below.

In one example registration, as shown in Table 1, the consumer 112 (John Doe) may be associated with a payment account having a primary account number (PAN) of 1111-2222-3333-4444. In connection with registration of the consumer 112 with the loyalty engine 116, the PAN may be provided to the loyalty engine 116 by the consumer 112 and/or the issuer 108. During such registration, via the loyalty engine API, the consumer 112 then provides multiple different loyalty account indicators to the engine 116, which are stored in the loyalty data structure 118. The different loyalty account indicators are stored in association with the consumer's payment account. As shown in Table 1, in this example, the consumer's PAN is associated, as stored in the data structure 118, with three airline loyalty accounts (e.g., United®, America Airlines®, and Delta®, etc.), three hotel loyalty accounts (e.g., Marriott®, Hyatt®, and SPG®, etc.), and also four other retailer loyalty accounts, etc.

TABLE 1

| | Loyalty Accounts |
|---|---|
| Name: | Airlines |

| | | |
|---|---|---|
| John Doe | United | 111-222A |
| Primary Account | AA | 1234-1234 |
| Number: | Delta | DEL1234 |

| | |
|---|---|
| 1111 2222 3333-4444 | Hotels |

| | |
|---|---|
| Marriott | 123456 |
| Hyatt | 6543211 |
| SPG | 5678891 |

Other Retailers

| | |
|---|---|
| CVS | 98321 |
| Rite Aid | 13579 |
| ShopRite | 246810 |
| Shell | 0912873 |

It should be appreciated that more or less loyalty accounts may be associated with a single payment account, or that multiple payment accounts may be associated with common loyalty accounts, in other exemplary embodiments. Also as shown, in Table 1 the data structure 118 includes the association between the PAN and the multiple loyalty accounts, and in particular, the loyalty account indicators provided by the respective merchants (e.g., the 111-222A indicator provided by United®, etc.). In at least one embodiment, as described below, the loyalty account indicator may include an indicator generated by the loyalty engine 116, which is unique and indicative of the consumer 112, the consumer's loyalty account, and/or the consumer's payment account, etc. Further, it should be appreciated that any different type of loyalty account may be associated with the payment account in the data structure 118, including, for example, grocery loyalty accounts, clothing retail loyalty accounts, restaurant loyalty accounts, travel loyalty accounts, etc. In at least one embodiment, only certain loyalty accounts offered by certain merchants may be eligible for association, by the loyalty engine 116, based on one or more relationships between the payment network 106, the merchant 102, and/or the issuer 108.

Once the loyalty accounts are stored in the data structure 118, the loyalty engine API may be called subsequently, via the issuer's web-based interface (e.g., via the issuer's website, via a web-based application active on the consumer's portable communication device 114, etc.) to check loyalty status, redeem loyalty rewards, change registration information/options, etc.

With continued reference to FIG. 1, and with the data structure 118 is populated, the loyalty engine 116 of the system 100 may be configured in a variety of manners to use the data structure 118 in conjunction with transactions to payment accounts included therein. The particular configuration of the loyalty engine 116 is based on what part of system 100 manages the loyalty accounts to update loyalty reward values for the consumer 112, in whole or in part. Often, the loyalty engine 116 is configured, based on transactions to payment accounts, to directly update the consumer's loyalty accounts and/or to provide data to the merchant 102 to allow for such updates.

As an exemplary configuration of the loyalty engine 116, the merchant 102 may manage a loyalty account for the consumer 112, which has been associated with the consumer's payment account, via the loyalty engine 116. In this example, when the consumer 112 initiates a transaction at the merchant 102, the loyalty engine 116 is configured to receive an authorization message for the transaction, initiated from either the merchant 102 (as an authorization request) or the issuer (as an authorization reply), and determine if the PAN included in the authorization message is associated with the loyalty account provided by the merchant 102. If the PAN is associated with the loyalty account, the loyalty engine 116 is configured to then embed an indicator for the loyalty account into the authorization message (e.g., loyalty indicator 120 in an ISO 8583 authorization message 122 as shown in FIG. 1, etc.) or otherwise embed the indicator in transaction data (as described above) associated with the transaction. As such, the merchant 102 may be able to check the authorization reply for the loyalty account indicator, which would indicate an update to the consumer's loyalty account is necessary. The merchant 102 is then able to update the loyalty account, as necessary. In other embodiments, the loyalty engine 116 may embed the loyalty indicator to a clearing message associated with the transaction, or other message.

As another exemplary configuration of the loyalty engine 116, the merchant 102 may again manage a loyalty account for the consumer 112 associated with the consumer's payment account. In this example, when the consumer 112 initiates a transaction at the merchant 102, the merchant 102 may request transaction data, at the time of the transaction, or at a later time (e.g., at the end of the day, week, etc. as a batch request for multiple transactions), to determine if the transaction(s) relates to the loyalty account(s) provided by the merchant 102. In particular, for example, the loyalty engine 116 is configured, via the API in FIG. 1 called by the merchant 102 (as indicated by the dotted line), to provide transaction data to the merchant 102, that, in turn, determines if a loyalty account indicator for the consumer 112 is present for the transaction by the consumer 112 and for certain other transactions involving the merchant 102. The merchant 102 is then able to update the loyalty account, as necessary.

As still another exemplary configuration, the loyalty engine 116 is configured to manage one or more of the loyalty accounts for the merchant 102, and for other merchants. In this example, the loyalty data structure 118 (or another associated data structure) may further include a loyalty reward value associated with each loyalty account for the consumer 112, which may then be updated by the loyalty engine 116. The value (in this and other examples) also may indicate the consumer's progress toward rewards, or it may simply track the value of the consumer's current reward level. Such tracking may be done in generic points, dollars (or other currencies), tallies, total purchases, particular product purchases (e.g., a number of sandwiches purchased, etc.), travel miles, or the like. Table 2, for example, illustrates a part of the data structure 118, in which the different loyalty accounts associated with PAN 1111-2222-3333-4444, as provided in Table 1 are included, but with loyalty reward values also included for each account.

TABLE 2

| | Loyalty Account | | Points | Expiration |
|---|---|---|---|---|
| Name: | Airlines | | | |
| John Doe | United | 111-222A | 325,500 | Dec-20 |
| Primary Account | AA | 1234-1234 | 22,455 | Never |
| Number: | Delta | DEL1234 | 114,300 | Dec-22 |
| 1111 2222 3333-4444 | Hotels | | | |
| | Marriott | 123456 | 32,140 | Dec-18 |
| | Hyatt | 6543211 | 14,930 | Dec-18 |
| | SPG | 5678891 | 3,600 | Dec-18 |
| | Other Retailers | | | |
| | CVS | 98321 | 0 | Dec-18 |
| | Rite Aid | 13579 | 142,143 | Dec-18 |
| | ShopRite | 246810 | 42 | Dec-18 |
| | Shell | 0912873 | 17,525 | Dec-18 |

In the above exemplary configuration, the loyalty engine 116 is specifically configured to receive an authorization message, initiated from either the merchant 102 (as an authorization request) or the issuer (as an authorization reply), and to determine if the PAN included in the authorization message is associated with the loyalty account provided by the merchant 102. If the PAN is associated with the loyalty account, the loyalty engine 116 is configured to then update the loyalty account value for the account. The loyalty engine 116 may further be configured to identify reward data from the authorization message. Or, the merchant 102 may send transaction data (e.g., SKU data, etc.) to the loyalty engine 116 (e.g., in batch at the end of the day, etc.), via the loyalty engine API between the loyalty engine 116 and the merchant 102, and the loyalty engine 116 may then use the data received from the merchant 102 to update the consumer's loyalty account value.

Regardless of whether the loyalty account is managed by the merchant 102 or the loyalty engine 116, additional requirements and/or qualifications may be employed prior to, or as a condition of, updating a loyalty account. For example, the merchant 102 may only permit an update (e.g., an addition or subtraction, etc.) to the loyalty account value, when the transaction includes a product of a specific type, or when the transaction reaches a specific total, and/or when using a particular coupon and/or offer, etc. Other requirements and/or qualifications related to the transaction, the time/date, the consumer, the merchant, etc. may be employed in other embodiments. Further, the manner in which the loyalty account value is updated may be based on one or more factors as well, such as double value for spending over $50.00, or for spending with a coupon or special offer, etc.

It should be appreciated that in addition to the above, the loyalty engine 116 may also be configured to provide certain notifications to the merchant 102, the issuer 108, and/or the consumer 112. The notification may related to the loyalty account value or other attribute of a particular loyalty account, a coupon and/or offer for redemption related to the loyalty account and/or the merchant 102, etc.

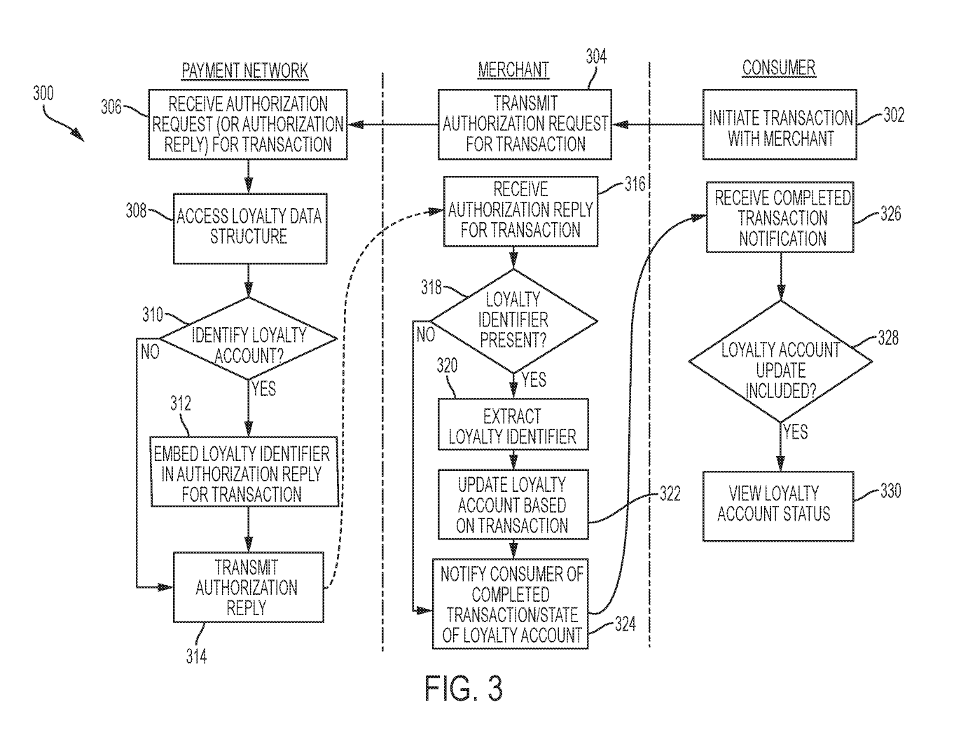

FIG. 3 illustrates an exemplary method 300 for assigning rewards to a loyalty account, following a transaction to a payment account, based on an association of the loyalty account with the payment account. The exemplary method 300 is described as implemented in the loyalty engine 116, in connection with interactions between the consumer 112, the merchant 102, and the payment network 106 of system 100. However, it should be understood that the method 300 is not limited to this configuration, as the method 300 may be implemented in other parts (or combination of parts) of the system 100 and/or other ones (or combinations of ones) of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

As shown in FIG. 3, the method 300 generally begins when the consumer 112 initiates a transaction with the merchant 102, at 302, for a product (or products), as generally described above in connection with the system 100, using the consumer's payment account. At 304, the merchant 102 transmits an authorization request (broadly, an authorization message) for the transaction to the payment network 106, via the acquirer 104. The authorization request may include, for example, a PAN for the consumer's payment account and a merchant ID for the merchant 102. Then, upon receipt of the authorization request, at 306, the loyalty engine 116 (at the payment network 106) accesses the loyalty data structure 118, at 308. Alternatively, the loyalty engine 116 may not access the loyalty data structure 118, at 306, until a reply to the authorization request is received from the issuer 108, approving the transaction.

In connection with accessing the loyalty data structure 118, the loyalty engine 116 determines, at 310, if the consumer's payment account (e.g., based on the PAN, etc.) used in the current transaction (as identified from transaction data for the transaction) is associated with a loyalty account. The loyalty engine 116 also identifies the particular loyalty account associated with the consumer's payment account that may be implicated by the transaction, based on the merchant ID for the merchant 102 or other purchase parameter. In so doing, the loyalty engine 116 generally determines if the transaction is compatible with one (or more) of the loyalty accounts associated with the consumer's payment account. At this time, the loyalty engine 116 may also determine if the transaction satisfies any purchase parameters associated with the loyalty account, in order for the consumer 112 to earn rewards to the identified loyalty account for the transaction (e.g., minimum purchase amount parameters, specific product purchase parameters, etc.).

When the loyalty engine 116 determines that the consumer's payment account is associated with a loyalty account implicated by the transaction, the loyalty engine 116 embeds a loyalty indicator for the implicated loyalty account in the authorization reply, at 312 (or in the authorization request, before transmitting the authorization request to the issuer 108, etc.). The loyalty engine 116 then transmits the authorization reply, at 314, to the merchant 102. The loyalty engine 116 may also notify the consumer 112 of the reward transaction and/or provide the consumer 112 with information about the consumer's identified loyalty account (e.g., via a reward notification message, etc.), for example, via the consumer's account with issuer 108 or directly to the consumer's communication device 114 (via the loyalty application). However, when the loyalty engine 116 determines, at 310, that the consumer's payment account is not associated with a loyalty account implicated by the transaction, the loyalty engine 116 simply transmits the authorization reply to the merchant 102, at 314, without embedding a loyalty indicator.

In either case in the method 300, the merchant 102 receives the authorization reply, at 316. And, at 318, the merchant 102 determines if the reply includes a loyalty indicator.

When a loyalty indicator is found in the authorization reply, the merchant 102 (or a part of the loyalty engine 116 located at the merchant 102) extracts the loyalty indicator from the reply, at 320, and updates the appropriate loyalty account for the consumer based on the transaction, at 322 (without the consumer 112 separately presenting the loyalty account indicator to the merchant). The update may include updating the total point value (or loyalty reward value), recording transaction information, incrementing a purchase tally, calculating available rewards based on a new total of points, etc. For example, the update may be done to the loyalty reward value for the consumer's account based on a purchase total for the transaction, and when a product identifier for the purchased product is indicative of an eligible product for rewards to the loyalty account. This can be done in real time, or this may be done as part of a batch process (e.g., at the end of a business day, etc.). The merchant 102 then notifies the consumer 112 of the completed transaction and/or provides the consumer 112 with information about the state of the consumer's loyalty account, at 324 (e.g., via a reward notification message, etc.).

When a loyalty indicator is not found in the reply to the authorization request, the merchant 102 may simply notify the customer of the completed transaction, at 324. In some embodiments, if the merchant 102 determines that the transaction has not been authorized or otherwise failed, the merchant 102 may immediately notify the consumer 112 of the transaction failure without checking for a loyalty account identifier.

It should be appreciated that while the loyalty account indicator is included in the authorization message, in the above description, that the loyalty account indicator may be associated with the transaction in other manners by the issuer 108 and/or payment network 106. In such embodiments, the merchant 102 may retrieve the transaction data (including the loyalty account indicators, where present) via an API call to the loyalty engine 116. In this manner, the merchant 102, for example, at the end of a business day, while compiling transaction records, may in a single call to the loyalty engine 116 retrieve the necessary loyalty account indicators for the day's transactions (or other interval) to perform as described herein.

With continued reference to FIG. 3, at 326 in the method 300, the consumer 112 receives the notification from the merchant 102. When a loyalty account update is included in the notification, 328, the consumer 112 may then view the loyalty account status, at 330. If the transaction is via a website, the notification may be in the form of a display on the screen of consumer's communication device 114 and/or an email message or the like. If the transaction takes place at a physical location, the notification may appear on a screen at a point-of-sale device, or may be printed on a receipt that is provided to the consumer 112.

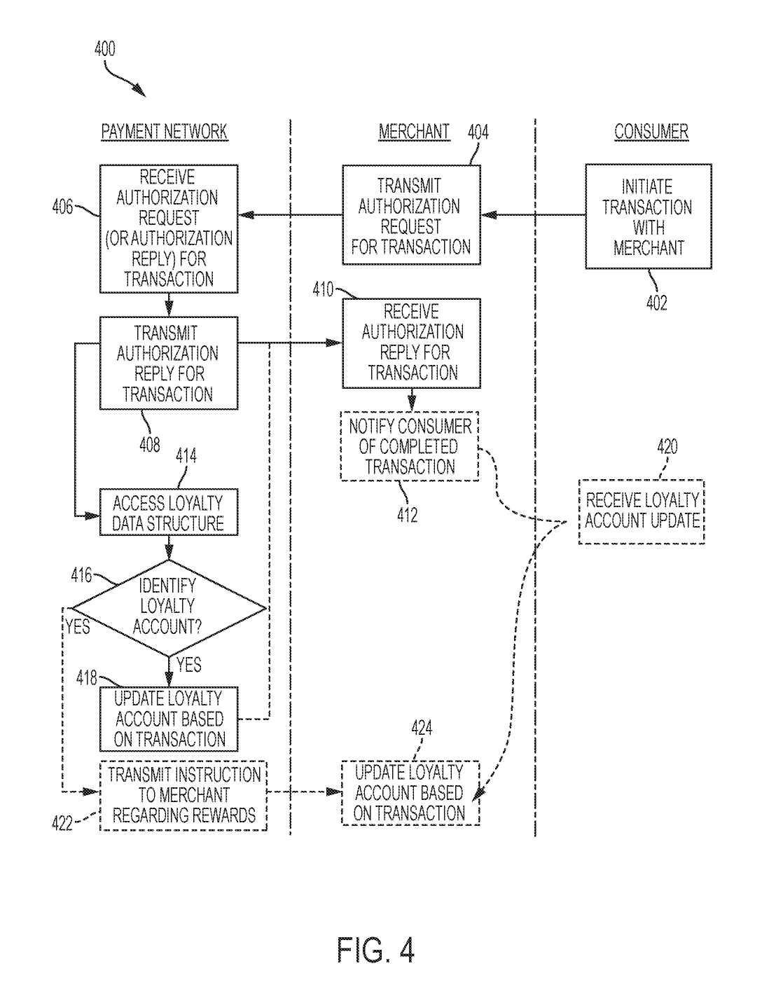

FIG. 4 illustrates another exemplary method 400 for assigning rewards to a loyalty account, following a transaction to a payment account, based on an association of the loyalty account with the payment account. The exemplary method 400 is again described as implemented in the loyalty engine 116, in connection with interactions between the consumer 112, the merchant 102, and the payment network 106 of system 100. However, it should be understood that the method 400 is not limited to this configuration, as the method 400 may be implemented in other parts (or combination of parts) of the system 100 and/or other ones (or combinations of ones) of the computing devices 200 in system 100, or in multiple other computing devices. As such, the systems and the computing devices herein should not be understood to be limited to the exemplary method 400.

As shown in FIG. 4, the method 400 generally begins when the consumer 112 initiates a transaction with the merchant 102, at 402, for a product (or products), as generally described above in connection with the system 100, using the consumer's payment account. For example, at 404, the merchant 102 transmits an authorization request for the transaction to the payment network 106 and issuer 108, via the acquirer 104. The authorization request may include, for example, a PAN for the consumer's payment account, a merchant ID for the merchant 102, at least one purchase parameter for the transaction such as purchase price, etc. The payment network 106 receives the authorization request (and subsequently, the authorization reply), at 406. The payment network 106 then transmits the authorization reply, at 408, to the merchant 102, and the merchant 102 receives the reply, at 410. The merchant 102 may, optionally (as indicated by the broken lines in FIG. 3), send a notification to the consumer 112 of the completed transaction, at 412. The completed transaction notification may be in the form of a receipt from a point-of-sale terminal, or message to the consumer's communication device 114, etc.

Separately in the method 400, upon receipt of the authorization reply at the payment network 106, at 408, the loyalty engine 116 (at the payment network 106) accesses the loyalty data structure 118, at 414. In connection therewith, the loyalty engine 116 determines, at 416, if the consumer's payment account used in the current transaction (as identified from transaction data for the transaction) is associated with a loyalty account implicated by the transaction. In particular, the loyalty engine 116 identifies a loyalty account associated with both the merchant ID and the PAN for the consumer's payment account, and then determines if the at least one purchase parameter for the transaction satisfies any reward requirements for the loyalty account. In so doing, the loyalty engine 116 generally determines if the transaction is compatible with one (or more) of the loyalty accounts associated with the consumer's payment account.

When the loyalty engine 116 determines that the consumer's payment account is associated with a loyalty account implicated by the transaction, the loyalty engine 116 (at the payment network 106) updates the consumer's implicated loyalty account, at 418, based on the transaction 322 (without the consumer 112 separately presenting the loyalty account indicator to the merchant 102). The update may include updating the total point value (or loyalty reward value), recording transaction information, incrementing a purchase tally, calculating available rewards based on a new total of points, applying a statement credit to the consumer's payment account, etc. For example, the update may be done to the loyalty reward value for the consumer's account based on a purchase total for the transaction, and when a product identifier for the purchased product is indicative of an eligible product for rewards to the loyalty account. In so doing, the loyalty account value associated with the loyalty account may be updated by adding a percentage of the purchase total to the loyalty account value, or otherwise. Further, in connection with a personal card link offer (PCLO), when the loyalty engine 116 determines that the consumer's payment account is associated with a loyalty account implicated by the PCLO transaction, the loyalty engine 116 (at the payment network 106) applies the PCLO, when appropriate, to the consumer's payment account (e.g., as a statement credit, etc.) in connection with updating the consumer's loyalty account, at 418.

The consumer 112 may then, optionally (as indicated by the broken lines in FIG. 4) in the method 400, receive a notification from the loyalty engine 116 (via the payment network 106), at 420, informing the consumer 112 that his/her loyalty account has been updated (via the merchant and operations 410 and 412). The consumer 112 may also be able to view the loyalty account status as a result of the notification. For example, the notification may be in the form of an email, a short message service (SMS) message, or an app notification on the communication device 114 of the consumer 112 and may include a link to allow the consumer 112 to access the loyalty account. The notification may occur immediately, or it may be sent at a later time, such as at a pre-determined interval or time of day.

Alternatively in the method 400 (as indicated by the broken lines in FIG. 4), when the loyalty engine 116 determines, at 416, that the consumer's payment account is associated with a loyalty account implicated by the transaction, the loyalty engine 116 (via the payment network 106) may transmit an instruction, at 422, to the merchant 102, associated with the implicated loyalty account (or to the issuer 108, as appropriate), regarding the transaction and the rewards earned by the transaction. The merchant 102 (e.g., separately or via a part of the loyalty engine 116 associated therewith, etc.) may then update the consumer's implicated loyalty account, at 424, based on the transaction. The consumer 112 may then, again, receive a notification from the loyalty engine 116 (via the payment network 106), at 420, informing the consumer 112 that his/her loyalty account has been updated.

When the loyalty engine 116 determines, at 416, that the consumer's payment account is not associated with a loyalty account implicated by the transaction, the loyalty engine 116 (at the payment network 106) takes no further action regarding reward processing for the transaction.

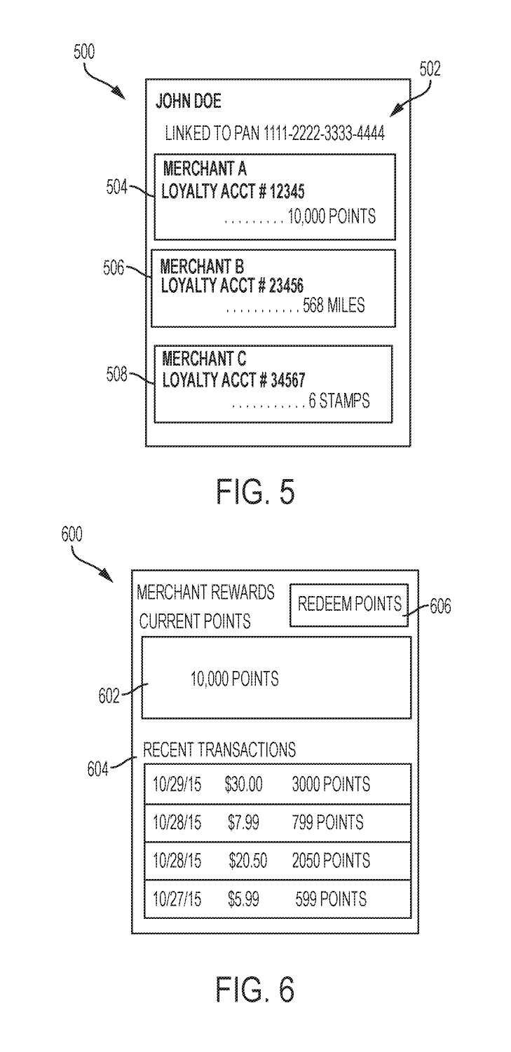

FIGS. 5 and 6 illustrate exemplary reward interfaces 500, 600 that may be displayed to the consumer 112, for example, by the loyalty engine 116 (or other part of the system 100), at the consumer's communication device 114 via the loyalty application installed on the communication device 114 or through the issuer's website (e.g., upon logging into their account, etc.).

The interface 500 displays general information about the different loyalty accounts associated with the consumer's payment account. The interface 500 may be displayed to the consumer 112, at the communication device 114, upon request by the consumer (e.g., upon logging into the consumer's loyalty account, upon access the loyalty application at the consumer's communication device 114, etc.), or as a result of a notification received from the loyalty engine 116. In particular, the interface 500 includes an indicator 502 of the PAN for the consumer's payment account, as well as fields 504, 506, 508 providing details of the consumer's loyalty accounts. In the illustrated interface 500, the fields 504, 506, 508 identify the particular merchant at which the loyalty account is provided (e.g., merchants A, B, C in the interface 500, etc.), an identifier for the loyalty account (e.g., an account number, etc.), and loyalty reward balance for the loyalty account. As shown, multiple various different types of rewards can be accommodated by the interface 500. For example, merchant A provides rewards in the form of points. Merchant B provides rewards in the form of miles. And, merchant C provides rewards in the form of stamps (e.g., virtual stamps or e-stamps, etc.). The fields 504, 506, 508 in the interface 500 can be selected by the consumer 112 to provide additional detail for the particular loyalty account.

The interface 600 displays further information about the consumer's loyalty account at merchant A, for example, in response to selection of the field 504 for merchant A in the interface 500. For example, the illustrated interface 600 includes a current points section 602, a recent transactions section 604 and a redeem points button 606. In the current points section 602, a total amount of points for the consumer's loyalty account at merchant A is displayed. In this case, the value is 10,000 points. The recent transactions section 604 includes information about recent transactions that have resulted in points for the loyalty account. Each transaction includes the date of the transaction, the total spent in the transaction, and the amount of points awarded for the transaction. In some embodiments, a total number of purchases from or visits to the merchant A and may be provided. In addition, in some embodiments, the recent transactions section 604 may include additional information about the transactions such as special factors that cause a certain transaction to result in more points than another transaction (e.g., if the loyalty account awards larger amounts of points for purchases at grocery stores, recent transactions from grocery stores may be highlighted or indicated as such on the interface 500). Further, in some embodiments, the consumer 112 may interact with the recent transactions to cause additional information about the transactions to be displayed on a separate screen and/or a different interface overlapping the interface 500.

The redeem points button 606 of the interface 600 enables the consumer 112 to access the stored value of the loyalty account and exchange that value for rewards, discounts, cash, etc. as described above. The button 606 may cause different and/or additional interfaces to be displayed which enable the consumer 112 to view choices for point redemption, such as items for purchase, cash back, discounts on additional or future purchases, discounts on travel expenses, etc.

While not shown, the interface 600 may also include a listing of any electronic coupons provided to the consumer 112, for example, from merchant A. For example, when merchant A transmits a PCLO to the consumer 112, the offer may be included in the consumer's loyalty account for merchant A and viewable (and, in some embodiments, redeemable) via the interface 600. Similarly, when merchant A transmits a virtual coupon to the consumer 112, the coupon may be included in the consumer's loyalty account for merchant A and viewable via the interface 600. Further, when the consumer 112 desires to coupon, the consumer 112 can access it via the interface 600, for example, at the consumer's communication device 114, and present the coupon to the merchant 102 (e.g., via rendered barcode for the coupon, etc.).

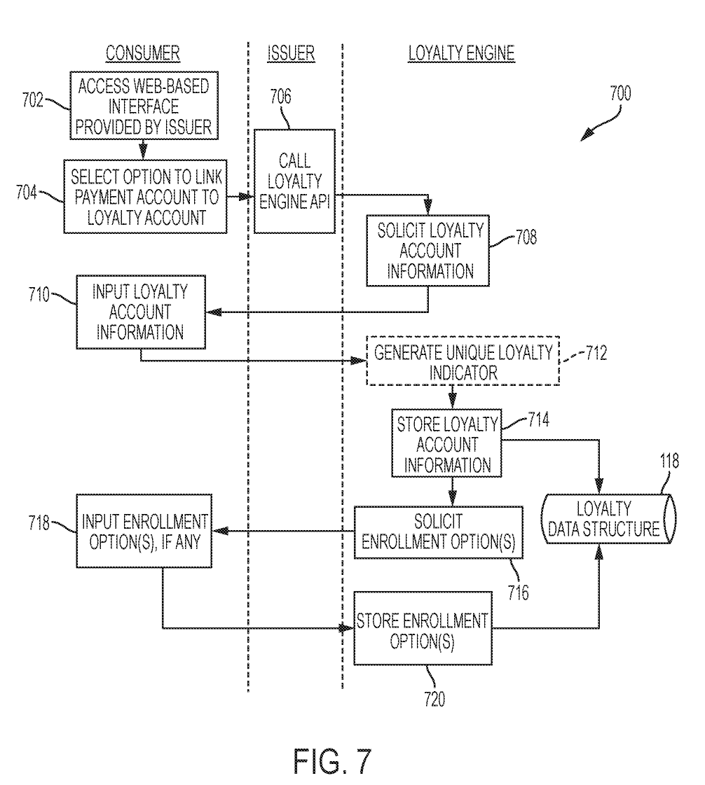

FIG. 7 illustrates an exemplary method 700 for managing association of loyalty accounts with a payment account. The exemplary method 700 is again described as implemented in the loyalty engine 116, in connection with interactions between the consumer 112 and the issuer 108 of system 100. However, it should be understood that the method 700 is not limited to this configuration, as the method 700 may be implemented in other parts (or combination of parts) of the system 100 and/or other ones (or combinations of ones) of the computing devices 200 in system 100, or in multiple other computing devices. As such, the systems and the computing devices herein should not be understood to be limited to the exemplary method 700.

As shown in FIG. 7, the consumer 112 initially accesses (e.g., logs into, etc.) a web-based interface associated with the issuer 108, at 702. As previously described, the issuer 108 is associated with (i.e., is the issuer of) the consumer's payment account. The interface is provided via a website associated with the issuer 108. Through the interface, the consumer 112 is able to access his/her payment account (e.g., via appropriate login credentials, etc.) and manage various parameters associated therewith. For example, the consumer 112 can view a transaction history for the payment account, statements, etc. In addition, the consumer 112 may be able to access other payment accounts associated with the consumer 112 and supported by the issuer 108.

In the illustrated method 700, upon accessing the web-based interface, the consumer 112 is provided with an option to associate (or link) loyalty accounts to the consumer's payment account (if not already done). When the consumer 112 selects the option, at 704, the issuer 108 (via the issuer's website) calls a loyalty engine API, at 706. The API, as part of the loyalty engine 116, cooperates with the issuer's website to provide multiple interfaces to the consumer 112 to obtain information relating to the consumer's loyalty accounts. The interfaces may be used to initially register the consumer 112 to a loyalty account management platform supported by the loyalty engine 116, or the interfaces may be used to receive edits to information already included in the consumer's platform. In either case, at 708, the loyalty engine 116, via the interfaces, solicits various information from the consumer 112 relating to the consumer's loyalty accounts that are to be associated with (or that are already associated with) the consumer's payment account. And, in response, the consumer 112 provides input to the interfaces, at 710, with the requested information relating to the loyalty accounts.

As described, soliciting the loyalty account information from the consumer 112, at 708, may include an initial registration for the platform and the loyalty engine 116. In connection therewith, the consumer 112 may also be prompted by the loyalty engine 116, via the interfaces, to generate access credentials (e.g., a user name and password, etc.) and provide a listing of all payment accounts and/or loyalty accounts to be associated (e.g., see Table 1, etc.). Alternatively, soliciting the loyalty account information from the consumer 112, at 708, may simply include updating information currently present in the consumer's account.

In addition, it should be appreciated that through use of the loyalty engine API, the consumer 112 is able to associate the loyalty accounts with the payment account at the issuer 108 (i.e., at the issuer's website), through the consumer's account at the issuer 108. However, because the loyalty engine API is called via the issuer's website, the consumer 112 is able to seamlessly interact with the loyalty engine 116, while generally being unaware that he/she is do so, thereby permitting the consumer 112 to facilitate the account associations at the issuer 108 without separately accessing the loyalty engine 116.

With continued reference to FIG. 7, optionally in the method 700 (as indicated by the broken lines in FIG. 7), the loyalty engine 116 generates a unique loyalty indicator for each of the consumer's loyalty accounts, at 712, so that the loyalty accounts can be subsequently identified and distinguished by the loyalty engine (e.g., when communicating reward notifications with the merchant 102, the issuer 108, etc.). The loyalty engine then stores, at 714, the received information, and the loyalty indicators, for the loyalty accounts in the loyalty data structure 118 in association with the consumer's payment account. In this manner, the consumer's different loyalty accounts are associated with his/her payment account (e.g., with the PAN for the payment account, etc.) in the data structure 118.

Next in the method 700, the loyalty engine 116 solicits enrollment options (or loyalty account management options) from the consumer 112, at 716, regarding the associations between the consumer's loyalty accounts and the consumer's payment account. In response, the consumer 112 inputs, at 718, the options to one (or more) of the various interfaces provided by the loyalty engine API. The enrollment options may include, for example, an election by the consumer 112 to participate in a particular reward program (e.g., a virtual stamp program or eStamp program, a paper voucher program, etc.), an election by the consumer 112 to receive particular offers (e.g., personal card link offers (PCLOs), etc.), an election by the consumer to download and install a loyalty application to the consumer's communication device 114 (if not already installed), an election to associate the consumer's communication device 114 (e.g., a phone number, etc.) with one or more of the loyalty accounts (e.g., for subsequent use in redeeming rewards, etc.), an election to activate and/or use particular reward offers already earned by or provided to the consumer 112, etc. The loyalty engine then stores, at 720, the received information for the enrollment options in the loyalty data structure 118 in association with the consumer's loyalty accounts and payment account.

It should be appreciated that consumers (e.g., consumer 112, etc.) may maintain many different loyalty accounts that are specific to different merchants and that result in rewards via different mechanisms. Some loyalty accounts may grant points or percentage values of cash back for total amounts of purchases. While other loyalty accounts may operate as virtual punch cards that tally purchases at merchants until particular numbers of purchases or amounts are achieved. In addition, in some embodiments, rewards may be awarded to consumers for other reasons. For example, the consumer 112 may have a loyalty account that requires the consumer 112 to make purchases during a specific time period, such as around lunch time, or during a particular season.

In one example, the consumer 112 may be associated with a loyalty account provided by the merchant 102 that includes a virtual punch card (e.g., eStamps, etc.). In connection therewith, the consumer 112 may earn “stamps” to the virtual punch card for purchases at the merchant 102. Some stamps may be earned based on a total amount spent at the merchant 102 (e.g., one stamp per five dollars spent, etc.), while other stamps may be earned based on particular products purchased (e.g., at a SKU level such as one stamp per coffee purchased, etc.). In both cases, the stamps may then be redeemable for products at the merchant 102 when a predefined total number of stamps are earned. In another example, the consumer 112 may receive coupons and/or PCLOs from the merchant 102 (e.g., in connection with a loyalty account provided to the consumer 112 by the merchant 102, etc.). The coupons may include barcodes that then allow the consumer 112 to redeem them by presenting the offers (and, particularly the barcodes) to the merchant 102, for example, via the consumers' communication device 114 or otherwise. In both examples, the virtual punch card, coupons, and PCLOs may be available to the consumer through the web-based application provided by the issuer 108, as described above, or through the loyalty application installed at the consumer's communication device 114. The consumer can then view each, as desired, and make appropriate selections for using them.

It should also be appreciated that accrued rewards associated with the consumer's various loyalty accounts (e.g., points, dollars, miles, accrued products, etc.) may be redeemed in exchange for a variety of different products and/or in a variety of different manners.

As an example, the consumer 112 may select, using the communication device 114, a virtual coupon for redemption at the merchant 102 from a listing of such coupons included at their loyalty account. The consumer 112 may then be able to redeem the coupon at a point-of-sale terminal by scanning a barcode on the coupon. Any discount associated with the coupon is applied to the transaction, and the consumer completes the transaction by providing information for his/her payment account (e.g., the PAN, etc.). In connection with the transaction, the merchant 102 transmits data for the coupon to the loyalty engine 116 (e.g., indicating redemption of the coupon and value of the coupon, etc.), via the loyalty engine API, either in real time or in batch. The merchant 102 then separately transmits an authorization message for the transaction, as described in the system 100. When the coupon barcode includes a loyalty identifier for the consumer 112, the loyalty engine 116 updates the consumer's loyalty account upon receipt of the coupon data via the loyalty engine API (independent of the authorization message). However, when the coupon barcode does not include a loyalty identifier for the consumer 112, the loyalty engine 116 (e.g., at the payment network 106, etc.) uses transaction data from the authorization message to initially identify the consumer's loyalty account and then updates the account based on the coupon.

As another example, the consumer 112 may receive, via the loyalty application at his/her communication device 114, a PCLO for a five dollar reward if the consumer 112 spends fifty dollars at the merchant 102 in the next month. In turn, the consumer 112 initiates a transaction for a product with the merchant 102, as described in connection with the system 100, and transmits an authorization message for the transaction to the payment network 106 (via the acquirer 104). The loyalty engine 116 identifies the consumer's loyalty account, via the PAN included in the authorization message, for example, and causes the reward associated with the PCLO to be applied to the consumer's account when appropriate.

In view of the above, the systems and methods herein may permit streamlined handling of loyalty rewards accounts associated with a payment account based on transactions associated with the payment account. The storage and maintenance of links between the loyalty rewards accounts and payment accounts as well as additional loyalty rewards account information enables a consumer to more efficiently track loyalty rewards across multiple loyalty rewards accounts.

In some embodiments, the payment network 106 (or loyalty engine 116) may prompt the consumer 112, by reviewing the consumer's historical transactions, to apply for various loyalty programs that the consumer 112 currently does not belong. For example, the consumer's transactions may indicate several purchases at a particular hotel, but from the loyalty data structure 118 it can be determined that the consumer 112 is not enrolled in a reward program for the hotel (or has forgotten to provide loyalty information for the program if already a member).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a payment network, a message associated with a transaction to a payment account, the message including a primary account number (PAN) for the payment account, a merchant identifier for a merchant involved in said transaction, and at least one purchase parameter; (b) identifying, in a data structure maintained by the payment network, a loyalty account associated with both the merchant identifier and the payment account; and (c) causing, by the payment network, a loyalty account value associated with the loyalty account to be updated based on the at least one purchase parameter, whereby the loyalty account is updated by use of the payment account, without a consumer associated with the payment account and/or the transaction separately presenting an indicator of the loyalty account to the merchant.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a transaction associated with a payment account and including a primary account number (PAN) for the payment account and a merchant identifier for a merchant involved in said transaction; (b) identifying, in a data structure, a loyalty account associated with each of the merchant identifier and the payment account, the loyalty account associated with a loyalty account indicator; (c) embedding the loyalty account indicator in a transaction response message; and (d) causing the transaction response message to be transmitted to said merchant, via at least one network, whereby the merchant is able to identify the transaction to the loyalty account based on the transaction response message, without a consumer involved in the transaction separately presenting the loyalty account indicator to the merchant.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for processing loyalty rewards for a transaction, the method comprising:
receiving, by at least one computing device, a transaction associated with a payment account and including a primary account number (PAN) for the payment account and a merchant identifier for a merchant involved in said transaction;
identifying, in a data structure, a loyalty account associated with each of the merchant identifier and the payment account, the loyalty account associated with a loyalty account indicator;
embedding, by the at least one computing device, the loyalty account indicator in a transaction response message; and
causing, by the at least one computing device, the transaction response message to be transmitted to said merchant, via at least one network, whereby the merchant is able to identify the transaction to the loyalty account based on the transaction response message, without a consumer involved in the transaction separately presenting the loyalty account indicator to the merchant.

2. The computer-implemented method of claim 1, further comprising:
receiving, at the at least one computing device, prior to receiving the transaction, a request to associate the loyalty account with the payment account, the request including at least the PAN for the payment account and the loyalty account indicator; and
storing, in the data structure, the association between the payment account and the loyalty account indicator.

3. The computer-implemented method of claim 1, further comprising updating, by the at least one computing device, a loyalty reward value based on at least one purchase parameter associated with the transaction.

4. The computer-implemented method of claim 3, wherein the at least one purchase parameter includes a purchase total for the transaction.

5. The computer-implemented method of claim 3, wherein the at least one purchase parameter includes a product identifier; and
wherein updating the loyalty account value includes updating the loyalty account value when the product identifier is indicative of an eligible product.

6. The computer-implemented method of claim 3, further comprising embedding the loyalty account value in the transaction response message.

7. The computer-implemented method of claim 1, wherein the transaction response includes a ISO message; and
wherein the loyalty account ID is included in a segment designated in the ISO message.

8. The computer-implemented method of claim 1, wherein identifying the loyalty account includes accessing the data structure, the data structure including multiple PANs and multiple loyalty accounts associated with at least some of the PANs.

9. The computer-implemented method of claim 1, further comprising causing, by the computing device, a reward notification message to be delivered to a consumer associated with at least one of the payment account and the loyalty account after causing the transaction response message to be delivered.

10. A computer-implemented method for processing loyalty rewards for a transaction, the method comprising:
transmitting an authorization request for a transaction involving a consumer and a merchant, the authorization request being independent of a loyalty account for the consumer and associated with the merchant;
receiving an authorization reply for the transaction, the authorization reply including an indicator of the loyalty account for the consumer and associated with the merchant; and
updating, by at least one computing device, a loyalty account value for the consumer based on at least the authorization reply, thereby permitting the merchant to manage the loyalty account value without the consumer separately identifying the loyalty account when initiating the transaction.

11. A computer-implemented method for processing loyalty rewards for a transaction, the method comprising
receiving, at a payment network, a message associated with a transaction to a payment account, the message including a primary account number (PAN) for the payment account, a merchant identifier for a merchant involved in said transaction, and at least one purchase parameter;
identifying, in a data structure maintained by the payment network, a loyalty account associated with both the merchant identifier and the payment account; and
causing, by the payment network, a loyalty account value associated with the loyalty account to be updated based on the at least one purchase parameter, whereby the loyalty account is updated by use of the payment account, without a consumer associated with the payment account and/or the transaction separately presenting an indicator of the loyalty account to the merchant.

12. The computer-implemented method of claim 11, wherein identifying the loyalty account includes identifying said loyalty account from among multiple loyalty accounts in the data structure, the multiple loyalty accounts associated with said payment account, each of the multiple loyalty accounts associated with a different merchant and unique to said consumer.

13. The computer-implemented method of claim 11, wherein the at least one purchase parameter includes a purchase total for the transaction; and
wherein causing the loyalty account value associated with the loyalty account to be updated includes adding a percentage of the purchase total to the loyalty account value.

14. The computer-implemented method of claim 11, wherein the at least one purchase parameter includes a product identifier; and
wherein causing the loyalty account value associated with the loyalty account to be updated includes adding to the loyalty account value when the product identifier is indicative of a qualifying product.

15. The computer-implemented method of claim 11, wherein the message includes an authorization response from an issuer of said payment account.

16. The computer-implemented method of claim 15, further comprising embedding an indicator associated with the loyalty account and at least one of the loyalty account value and a loyalty value associated with the transaction to the authorization response, whereby the loyalty account value and/or the loyalty value associated with the transaction is able to be reported to the consumer.

17. The computer-implemented method of claim 15, further comprising embedding an indicator associated with the loyalty account in the authorization response and directing the authorization response to said merchant.

18. The computer-implemented method of claim 11, wherein the message includes at least one clearing message associated with the transaction.

19. The computer-implemented method of claim 11, wherein causing the loyalty account value associated with the loyalty account to be updated includes altering the loyalty account value based on the at least one purchase parameter; and
wherein the at least one purchase parameter includes at least one of a purchase total and a product identifier.

20. A system for use in processing transactions to payment accounts, the system comprising:
a memory including a data structure, the data structure including multiple primary account numbers (PANs), each associated with payment account, each PAN associated with at least one loyalty account; and at least one processor coupled with the memory and configured to:
in response to an authorization reply, identify a loyalty account associated with a PAN included in the authorization reply and specific to a merchant associated with the authorization reply, based on the data structure;
embed an indicator associated with the loyalty account in the authorization reply, prior to directing the authorization reply to the merchant; and
update a loyalty account value associated with the loyalty account based on the identification of the loyalty account, whereby the loyalty account value is updated without a consumer presenting a separate indicator for the loyalty account to the merchant.
